(19) United States
(12) Patent Application Publication
(10) Pub. No.: US 2017/0094006 A1
(43) Pub. Date: Mar. 30, 2017

(54) ASSESSING CONTENT DELIVERY NETWORK TARGET CONTENT CONSUMPTION

(71) Applicant: Fastly, Inc., San Francisco, CA (US)

(72) Inventor: Simon Wistow, San Francisco, CA (US)

(21) Appl. No.: 15/278,796

(22) Filed: Sep. 28, 2016

Related U.S. Application Data
(60) Provisional application No. 62/234,320, filed on Sep. 29, 2015.

(51) Int. Cl. H04L 29/08

(52) U.S. Cl. CPC H04L 67/2842; H04L 67/1097; H04L 67/2823; H04L 43/0876

(57) ABSTRACT

Systems, methods, apparatus, and software for transitional caching in content delivery networks includes edge cache nodes configured to receive and reply to content requests. Content can be cached in edge cache nodes before receiving user requests or retrieved from an origin server. A transitional cache node array is configured to receive content requests from edge cache nodes and to receive original content from edge cache nodes and/or origin servers, as well as to modify original content to generate modified content. Modified content can include re-written original content (e.g., translations), transcoded data (e.g., video), compressed or otherwise adjusted data (e.g., images), and transformed files (e.g., CSS and JavaScript files), among others. In addition to assisting with original and modified content flow to end users, transitional caching also can assist in threat detection and mitigation within a CDN, helping to protect the network, origin servers and the like.

### RELATED APPLICATIONS

This application hereby claims the benefit of and priority to U.S. Provisional Patent Application 62/234,320, titled “ASSESSING CONTENT DELIVERY NETWORK TARGET CONTENT CONSUMPTION,” filed Sep. 29, 2015, and which is hereby incorporated by reference in its entirety.

### TECHNICAL FIELD

Aspects of the disclosure are related to the field of content delivery networks and the like.

### TECHNICAL BACKGROUND

Network-provided content, such as Internet web pages and the like, are typically served to end users via networked computer systems. End user requests for network content are processed and the content is responsively provided over various network links. These networked computer systems can include origin or hosting servers that originally host network content, such as web servers for hosting a news website. However, computer systems consisting solely of individual content origins or hosts can become overloaded and slow due to frequent requests of content by end users.

Content delivery networks (CDNs) add a layer of caching between content providers' original servers and end users. Content delivery networks typically have multiple distributed cache nodes that provide end users with faster access to content. When an end user requests content, such as a web page, the request is handled by a cache node that is configured to respond to the end user request (e.g., instead of an origin server). Specifically, when an end user directs a content request to a given origin server, the domain name system (DNS) resolves to a cache node (frequently the node is selected as an optimized server) instead of the origin server and the cache node handles that request.

Thus a cache node acts as a proxy or cache for one or more origin servers. Various types of origin server content can be cached in the content delivery network's various cache nodes. When all or a portion of the requested content has not been cached by a cache node, that cache node typically requests the relevant content (or portion thereof) from the appropriate origin server(s) on behalf of the end user.

### OVERVIEW

Various implementations of assessing target content consumption in a content delivery network include selecting, identifying and/or defining target content and reference content. Such content can be defined by identifying URLs or other identifying data or information. Moreover, reference content can include pre-configured and/or pre-defined categories. Target content consumption data and reference content consumption data are collected and, if necessary, processed to permit comparisons of the target content consumption and reference content consumption. Such comparisons can yield useful information regarding CDN utilization, content delivery within the CDN, content traffic, and the effectiveness of advertising and other methods of promoting content.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the views. While multiple embodiments are described in connection with these drawings, the disclosure is not limited to the embodiments disclosed herein. On the contrary, the intent is to cover all alternatives, modifications, and equivalents.

FIG. 1 illustrates a communication system.

FIG. 2 illustrates a method of operation of a content delivery system.

FIG. 3 illustrates a non-limiting example of a content consumption data collection and processing unit.

FIG. 4A illustrates a non-limiting example of a user interface.

FIG. 4B illustrates a non-limiting example of a user interface.

FIG. 4C illustrates a non-limiting example of a user interface.

FIG. 5 illustrates a non-limiting example of an administration console or other user interface that provides relative content consumption, traffic and/or other metrics, data and/or information in a graphical depiction.

### DETAILED DESCRIPTION

Network content such as web content typically comprises text, hypertext markup language (HTML) pages, pictures, digital media content, video, audio, code, scripts, and/or other content viewable on and rendered by an end user device in a browser or other specialized application. Such network-provided content, such as Internet web pages and the like, is typically served to end users via networked computer systems that provide requested content over various network links. A content delivery network (a “CDN”) is an example of such a networked computer system.

Content delivery networks employ edge cache nodes that are configured to respond to end user requests for content (e.g., a web page) by sending the web page's “primary resource” (e.g., a hypertext mark-up language (HTML) file, such as XHTML or HTML5 files and the like) to an end user device's web browser, which “loads” (or “renders” or “parses”) the web page in accordance with an appropriate standard (e.g., the HTML5 specification) and/or model (e.g., the Document Object Model (DOM) that organizes the nodes of a document (web page) in a tree structure known as a DOM tree). Web browsers identify and organize the various elements of a web page to generate the page displayed on a user's device.

Implementations herein can be used to assess target content consumption in a content delivery network. Such implementations allow administrative users (i.e., an “admin users”) such as content providers to evaluate content demand, delivery and traffic relative to selected reference content traffic and related metrics. Such evaluations of relative CDN traffic and content consumption can provide origin servers and other participants in a CDN with important information regarding utilization of content, utilization of servers, geographic distribution of content, and other measurements that enable enhanced deployment of resources and the development and updating of content. Such evaluations can be implemented using data regarding the consumption of particular content of interest (“target content”) and data regarding the consumption of one or more content sources used for comparison purposes (“reference content”). Implementations include the identification of one or more target content sources and the identification of one or more reference content sources, then collecting data relating to the consumption of content from the identified sources, and finally comparing the collected data in one or more of a variety of ways to yield metrics, measurements and other useful data and information about the relative performance of the target content source(s) as compared to the reference content source(s) selected.

A target content source can be defined by designating one or more URLs that are used by end users to request target content, or by any other means that allows designation and/or definition of content whose consumption (i.e., delivery to an end user requesting the content) can be logged or otherwise tracked in a content delivery network. Use of URLs allows content to be defined without regard to the storage location of the target content within the content delivery network. For example, target content may include certain web pages and the like that can be stored in an origin server, a CDN content node, or any other storage location that can be found via end user requests that can be resolved by a domain name system (DNS) or other content-locating service or function. In addition to identifying the locator, source and/or location of the target content, target-defining criteria can include time definitions so that collection of target content consumption data is limited to prescribed time frames. In some implementations the relative comparisons and resulting metrics, measurements, etc. can be provided to an admin user in real time, thus permitting continuous monitoring of such data and information.

Like a target content source, a reference content source can be defined by identifying one or more URLs and by optionally establishing limits on the time period during which reference content consumption data is collected. In addition to permitting admin user definition of reference content, in some implementations, one or more reference content sources can be pre-defined or pre-configured so that defining a reference content source can be accomplished via a selection from a menu or other listing of categories or other reference identifications. For example, if automotive industry content is of interest for server utilization, content deployment, advertising, regulatory, safety, or other reasons, then a content delivery network might offer a reference content category for the automotive industry within which could be available selections for “Automotive Industry—Worldwide,” “Automotive Industry—United States,” “Automotive Industry—Europe,” “Automotive Industry—Trucks,” “Automotive Industry—Hybrid Vehicles,” so as to provide various reference content sources relating to that industry.

Reference content can also be defined in other ways. For example, reference-defining criteria can be utilized to permit an admin user to identify URLs and/or other reference-content-defining criteria by populating input fields in a graphical user interface (GUI) and/or other user interface. Other non-limiting examples of reference-content-defining criteria can include one or more of the following: industry definition, network segment definition, geographic definition, IP address definition, reference content time definition, URL definition, content type definition, subject matter definition.

Using the automotive industry field as an example, the target content may be a manufacturer's content pertaining to specific vehicle models or types (e.g., trucks, hybrid vehicles). Also, an auto dealer might want to track relative traffic and content consumption in related fields. By selecting and/or defining appropriate reference content, such parties can determine whether advertising is effective, when additional resources might be necessary to meet content demand, etc. In addition to reviewing assessments of traffic and content consumption during prior blocks of time, such users can also review real time comparisons so that adjustments to content and CDN resource allocations can be made on the fly.

Comparisons of collected target content consumption data and reference content consumption data can be made in various ways.

The comparison of the collected target content consumption data and reference content consumption data can be of whatever type defined by an admin user or made available by the operator of the content delivery network. For example, the relative number of end user requests for target content can be evaluated versus the number of end user requests for the reference content. Likewise, total bytes of data transferred regarding both types of content can be evaluated. The number of discrete IP addresses accessing the target content versus the reference content may also be useful. Other types of comparisons can be implemented as well. In some implementations a correlation of the relative data may be presented to illustrate some of these comparisons in real time and/or for a specified time period.

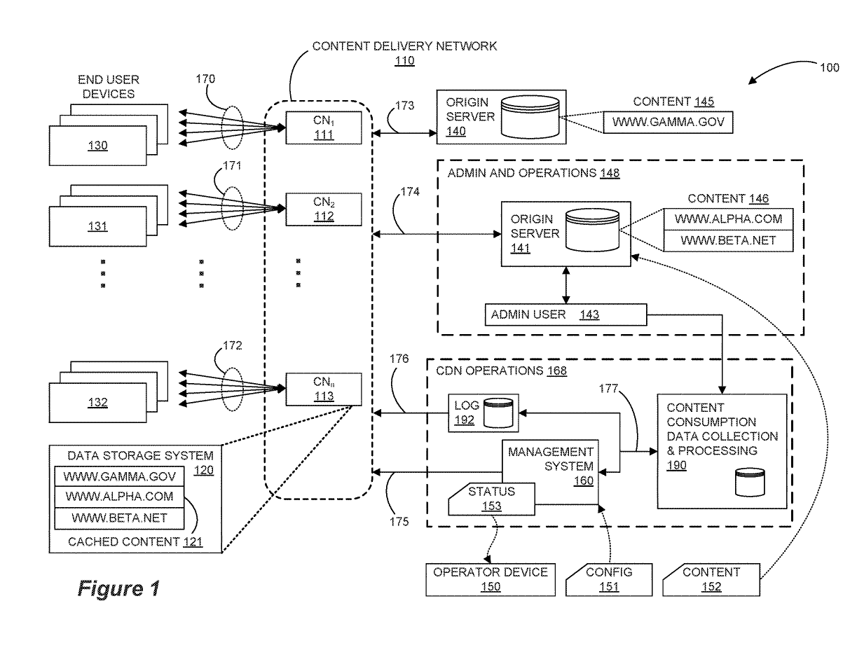

FIG. 1 illustrates an exemplary content delivery system 100 that includes content delivery network (CDN) 110, end user devices 130, 131, 132, origin servers 140-141, management system 160 and a content consumption data collection and processing unit 190—which may be a single unit or device, or may be made up of multiple units or devices working in concert. Content delivery network 110 includes one or more cache nodes (CNs) 111, 112, 113, each of which can include suitable processing resources and one or more data storage systems. Each CN 111-113 communicates with each other CN over CDN network links. Each of CN 111-113 can include one or more data storage systems, such as data storage system 120 illustrated for CN 113. End user devices 130-132 are representative of a plurality of end user communication devices that can request and receive (i.e., consume) content from network 110. The transfer of content from CDN 110 to a given end user device is initiated when a specific user device 130-132 associated with a given cache node 111-113 transmits a content request to its corresponding cache node (any number of end user devices 130-132 can be associated with a single cache node). Cache nodes 111-113 and end users 130-132 communicate over associated network links 170, 171, 172. Other network components likewise communicate over appropriate links. Content delivery network 110, management system 160 and log 192 communicate over links 175, 176.

Content cached in and/or obtained by one of the CNs 111-113 is used to respond to end user requests by transmitting requested content to the end user device. CNs 111-113 can cache content from origin servers 140-141 periodically, on demand, etc. and can also seek and obtain content that is not cached by communicating directly with origin servers 140-141 (e.g., over associated network links 173-174). FIG. 1 shows cached content 121 included in data storage system 120 of cache node 113 as comprised of content 145-146. Other configurations are possible, including subsets of content 145-146 being cached in individual ones of CN 111-113. Although FIG. 1 shows content 145-146 of origin servers 140-141 being cached by data storage system 120, other content can be handled by CN 111-113. For example, dynamic content generated by activities of end user devices 130-132 need not originally reside on origin servers 140-141, and can be generated due to scripting or code included in web page content delivered by CN 111-113.

Management system 160 and its associated components collect and deliver various administrative, operational and other data, for example network and component configuration changes and status information for various parties (e.g., system operators, origin server operators, managers and the like). For example, operator device 150 can transfer configuration data 151 for delivery to management system 160, where configuration data 151 can alter the handling of network content requests by CNs 111-113, among other operations. Also, management system 160 can monitor status information for the operation of CDN 110, such as operational statistics, and provide status information 153 to operator device 150. Moreover, operator device 150 can transfer content 152 for delivery to origin servers 140-141 to include in content 145-146. Although one operator device 150 is shown in FIG. 1, it should be understood that this is merely representative and communication system 100 can include multiple operator devices for receiving status information, providing configuration information, or transferring content to origin servers.

With specific regard to assessing target content consumption in connection with implementations within network 100, FIG. 1 illustrates one or more implementations of a target content consumption assessment system, where admin users can include (but are not limited to) individuals associated with various types of parties such as content providers, advertisers and others. Content consumption data collection and processing unit 190 is connected to various aspects of the CDN operation (e.g., management system 160 and/or log 192 via link 177, perhaps others). Origin server 141 of FIG. 1 is part of administration and operations 148 that also include an admin user unit 143, which can be one or more specialized or specially-configured computers and associated apparatus. The admin user unit 143 is in communication with the CDN's content consumption data collection and processing unit 190 through any suitable means. Implementations of admin user unit 143 can provide admin user personnel with graphical and/or other admin user means for communicating with unit 190, as noted in connection with various implementations disclosed herein. Unit 190 may also be connected to various other components of the admin user unit 143 and/or other content delivery network contact points in order to carry out actions that are initiated (e.g., invoked or otherwise called for) to assess target content consumption in CDN 110.

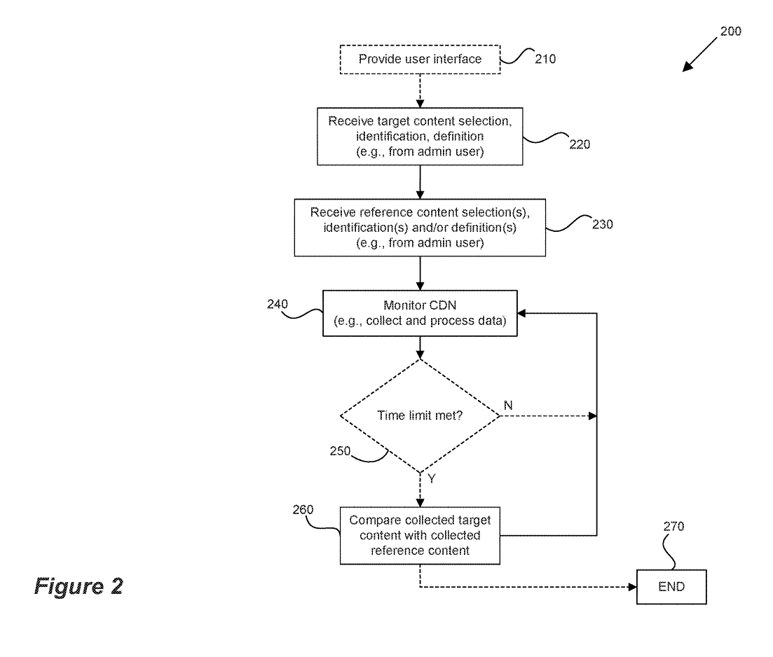

FIG. 2 illustrates one or more non-limiting examples of a method of operation 200 of a content delivery network implementing target content consumption assessment. Software stored on or in the content consumption data collection and processing unit 190 and/or one or more other locations can be used to implement one or more methods and can comprise computer program instructions, firmware, or some other form of machine-readable processing instructions having processes that, when executed by a processing system, direct a content delivery network to operate as described herein.

In method of operation 200 for assessing target content consumption using defined target content, a content delivery network optionally provides a user interface (210), for example a GUI to provide an admin user with a variety of input and/or selection options for the admin user's CDN account or the like. The content delivery network (e.g., through a content consumption data collection and processing unit or other input) then receives a selection, identification and/or definition of the target content (220), for example when an admin user selects a button or other indicator on a user interface or the like (e.g., a GUI, text interface, email), or when such an admin user inputs definitional information describing the target content.

The content delivery network then receives one or more selections, identifications and/or definitions of reference content (230), for example when an admin user selects a button or other indicator on a user interface or the like (e.g., a GUI, text interface, email), or when such an admin user inputs definitional information describing the reference content. As noted, in some implementations there may be pre-defined and/or pre-configured categories of reference content from which to select. The content delivery network is then monitored (250) by having the network collect (and process as necessary) target content consumption data and reference content consumption data. If the comparison(s) being made relative to the target content are for a pre-defined time period, then that can be checked (260). When the time limit is met, any final comparison can be made (260) and the operation can then end (270).

If the operation is to be done in real time, then ongoing comparison(s) can be made between the target content consumption and the reference content consumption (260). The operation 200 continues by continuing the collection and processing of relevant data (240) as defined.

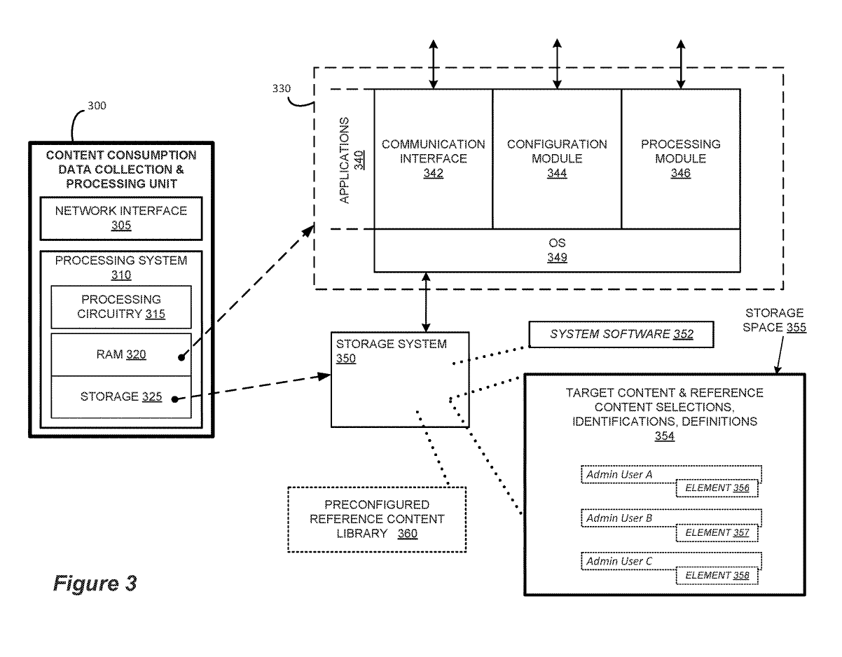

To further describe one or more implementations of the equipment and operation of assessing target content consumption in a content delivery network, FIG. 3 illustrates a non-limiting example of a content consumption data collection and processing unit 300. Unit 300 can be an example of content consumption data collection and processing unit 190 of FIG. 1, although variations are possible. Unit 300 includes network interface 305 and processing system 310, although further elements can be included. Processing system 310 includes processing circuitry 315, random access memory (RAM) 320, and storage 325, although further elements can be included. Exemplary contents of RAM 320 are further detailed in RAM space 330, and exemplary contents of storage 325 are further detailed in storage system 350.

Processing circuitry 315 can be implemented within a single processing device but can also be distributed across multiple processing devices or sub-systems that cooperate in executing program instructions. Examples of processing circuitry 315 include general purpose central processing units, microprocessors, application specific processors, and logic devices, as well as any other type of processing device. In some examples, processing circuitry 315 includes physically distributed processing devices, such as cloud computing systems.

Network interface 305 includes one or more network interfaces for communicating over communication networks, such as packet networks, the Internet, and the like. The network interfaces can include one or more local or wide area network communication interfaces which can communicate over Ethernet or Internet protocol (IP) links. Network interface 305 can include network interfaces configured to communicate using one or more network addresses, which can be associated with different network links. Examples of network interface 305 include network interface card equipment, transceivers, modems, and other communication circuitry. In some implementations the network interface 305 provides the communications link with an admin user (i.e., an admin user device) configuring one or more triggers using unit 300.

RAM 320 and storage 325 together can comprise a non-transitory data storage system, although other variations are possible. RAM 320 and storage 325 can each comprise any storage media readable by processing circuitry 315 and capable of storing software. RAM 320 can include volatile and nonvolatile, removable and non-removable media implemented in any method or technology for storage of information, such as computer readable instructions, data structures, program modules, or other data. Storage 325 can include non-volatile storage media, such as solid state storage media, flash memory, phase change memory, magnetic memory, or as illustrated by storage system 350 in this example. RAM 320 and storage 325 can each be implemented as a single storage device but can also be implemented across multiple storage devices or sub-systems. RAM 320 and storage 325 can each comprise additional elements, such as controllers, capable of communicating with processing circuitry 315. In some implementations, the storage media can be a non-transitory storage media. In some implementations, at least a portion of the storage media can be transitory. It should be understood that in no case are the storage media propagated signals.

Software stored on or in RAM 320 or storage 325 can comprise computer program instructions, firmware, or some other form of machine-readable processing instructions having processes that, when executed by a processing system, direct unit 300 to operate as described herein. For example, software drives unit 300 to receive admin user selections, instructions and information concerning target and reference content selection, identification and/or definition; to monitor, collect and process target content consumption data and reference content consumption data; and to execute and report on comparisons of various types relating to the collected target content consumption data and reference content consumption data. The software also can include user software applications. The software can be implemented as a single application or as multiple applications. In general, the software can, when loaded into a processing system and executed, transform the processing system from a general-purpose device into a special-purpose device customized as described herein.

RAM space 330 illustrates a detailed view of an non-limiting, exemplary configuration of RAM 320. It should be understood that different configurations are possible. RAM space 330 includes applications 340 and operating system (OS) 349. RAM space 330 includes RAM space for temporary storage of various types of data, such as dynamic random access memory (DRAM).

Applications 340 and OS 349 can reside in RAM space 330 during execution and operation of unit 300, and can reside in a system software storage space 352 on storage system 350 during a powered-off state, among other locations and states. Applications 340 and OS 349 can be loaded into RAM space 330 during a startup or boot procedure as described for computer operating systems and applications.

Applications 340 include communication interface 342, configuration module 344, and processing module 346. Communications interface 342 handles communications among and between one or more admin users, one or more other parties, one or more content consumption data collection and processing units 300 and one or more content delivery networks and their components.

Communication interface 342, configuration module 344 and processing module 346 each allow interaction between and exchange of data with components of unit 300. In some examples, each of communication interface 342, configuration module 344 and processing module 346 comprise an application programming interface (API). Communication interface 342 allows for exchanging data, messages, etc. in unit 300 by modules 344, 346, 348, and can also receive instructions to purge or erase data from unit 300. Configuration module 344 allows for configuring of various operational features of unit 300 based on selected, identified and/or defined target content sources and reference content sources.

Processing module 346 is configured to process data collected from the content delivery network and to do so, at least in part, in accordance with defined target content and reference content. Data collected can include data and data sources identified in connection with industry definitions, network segment definitions, geographic definitions, IP address definitions, reference content time definitions, URL definitions, content type definitions, subject matter definitions and others. Processing module 346 also can perform any comparisons of the target content consumption data and reference content consumption data called for as part of the assessment of target content consumption in the relevant content delivery network(s). Comparisons can be performed and yield statistic, metrics and other data or information relevant to the desired target content consumption evaluation.

Communication interface 342, configuration module 344 and processing module 346 can each communicate with external systems via network interface 305 over any associated network links. In further examples, one or more of elements 342, 344, 346 are implemented in VCL or VCL modules.

Storage system 350 illustrates a detailed view of a non-limiting, exemplary configuration of storage 325. Storage system 350 can comprise flash memory such as NAND flash or NOR flash memory, phase change memory, magnetic memory, among other solid state storage technologies. As shown in FIG. 3, storage system 350 includes system software 352, as well as defined target content and reference content selections, identifications, definitions, data and information 354 stored in storage space 355. As described above, system software 352 can be a non-volatile storage space for applications 340 and OS 349 during a powered-down state of trigger definition unit 300, among other operating software. Defined target content and reference content selections, identifications, definitions, data and information 354 include stored data including values, parameters, names, and other information that permit the collection, processing and comparison of target content and reference content. In the non-limiting example of FIG. 3, data and information in storage 354 include content selections, identifications and definitions associated with Admin User A (e.g., stored in element 356), Admin User B (e.g., stored in element 357), and Admin User C (e.g., stored in element 358).

In implementations where a reference content definition unit implements pre-configured and/or pre-defined target content, a library 360 of such data and/or information can be used. Storage system 350 can therefore also include library 360, which can be updated by unit 300 and/or from other sources of information (e.g., the CDN operator) via network interface 305. Content consumption data collection and processing unit 300 is generally intended to represent a computing system with which at least software 330 and 349 are deployed and executed in order to render or otherwise implement the operations, methods and processes described herein. However, unit 300 can also represent any computing system on which at least software 330 and 349 can be staged and from where software 330 and 349 can be distributed, transported, downloaded, or otherwise provided to yet another computing system for deployment and execution, or yet additional distribution.

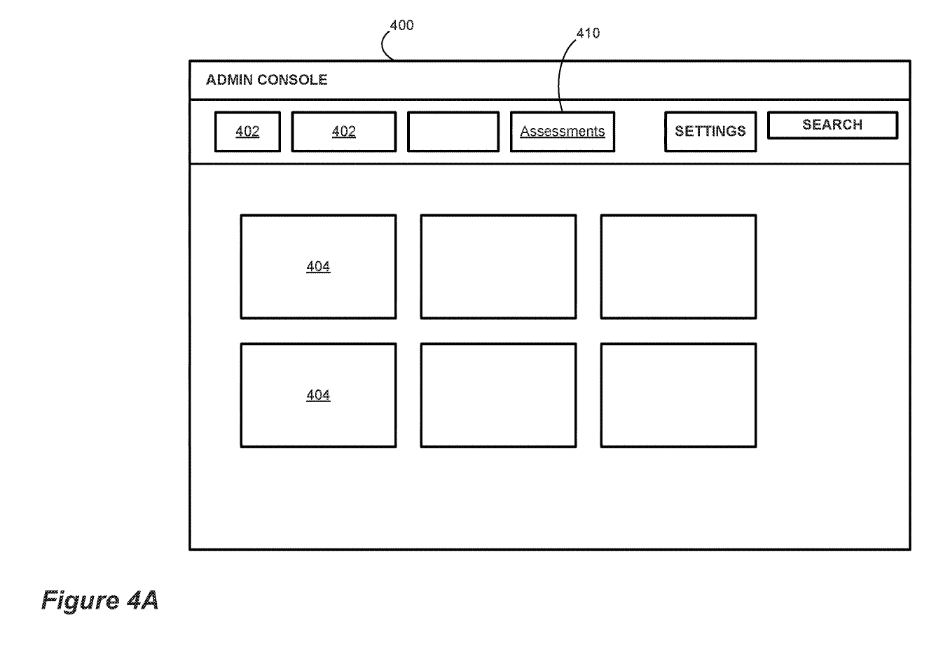

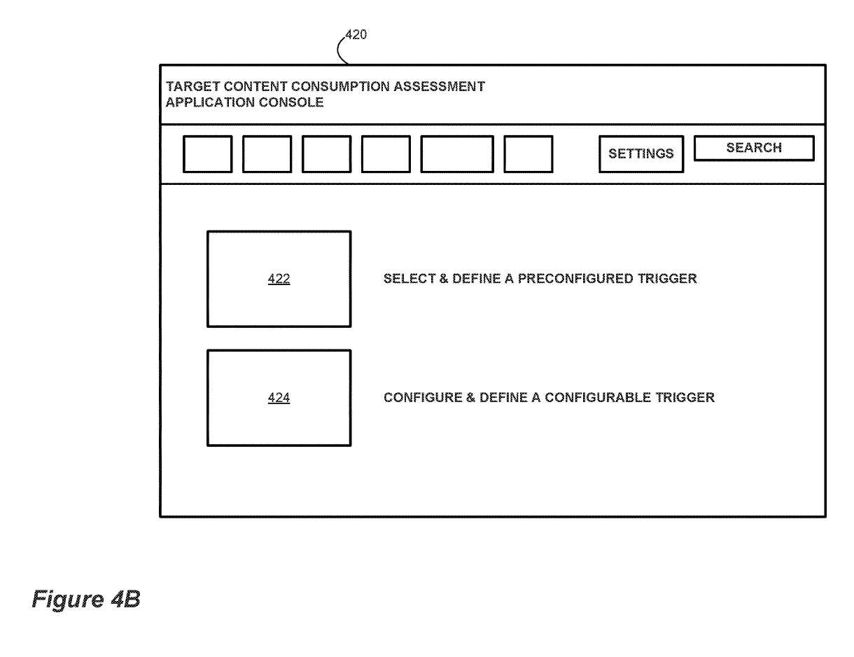

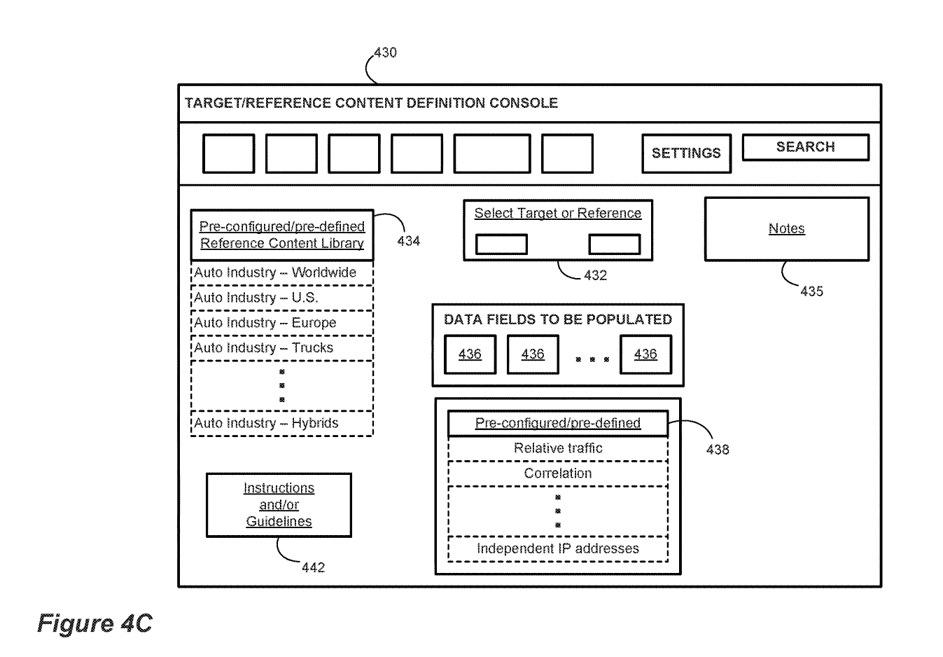

Various CDN interface modes and apparatus can be used to implement target content consumption assessment in a content delivery network. FIGS. 4A-4C illustrate implementations of interfaces for electronic display that can be used to set up and execute such assessments by an admin user. FIG. 4A provides a non-limiting example of an admin console that can be used to provide a CDN admin user with options for reviewing account and/or other information, content updates, etc. Among the options offered to an admin user on console 400 are selection buttons 402 (e.g., applications, utilities, etc.) and other selection panels 404 (e.g., account history and/or status, billing, etc.). Such a console can be provided to an admin user unit 143 or the like via software. Included in the non-limiting example of FIG. 4A is button 410 for “Assessments” that allows an admin user to select a target content consumption assessment application. FIG. 4B illustrates a sample target content consumption assessment application console 420 that provides an admin user with the tools required to define an assessment and its components using target content definition button 422 and reference content definition button 424.

FIG. 4C illustrates a non-limiting example of a console 430 that can be used to define target content and/or reference content. An admin user setting up an assessment of target content consumption in a content delivery network can use console 430 to define the relevant content source using a library or by entering content-defining criteria (e.g., URLs, content type, etc.). The relevant type of content (target or reference) can be selected using box 432. A drop-down menu 434 can enumerate available pre-configured and/or pre-defined reference content sources or types. A search function might also be available to allow an admin user to locate pre-configured and/or pre-defined reference content. Notes or other explanatory information 435 can be provided for a potential selection on console 430. Reference content also can be defined using content-defining criteria, for example by entering data in fields 436 (e.g., URLs identifying content sources).

Finally, the type of comparison or other operation to be performed with regard to the collected target content consumption data and reference content consumption data can be chosen from a menu 438. To the extent that an admin user needs assistance navigating and completing fields, etc., instructions and/or guidelines 442 can be provided.

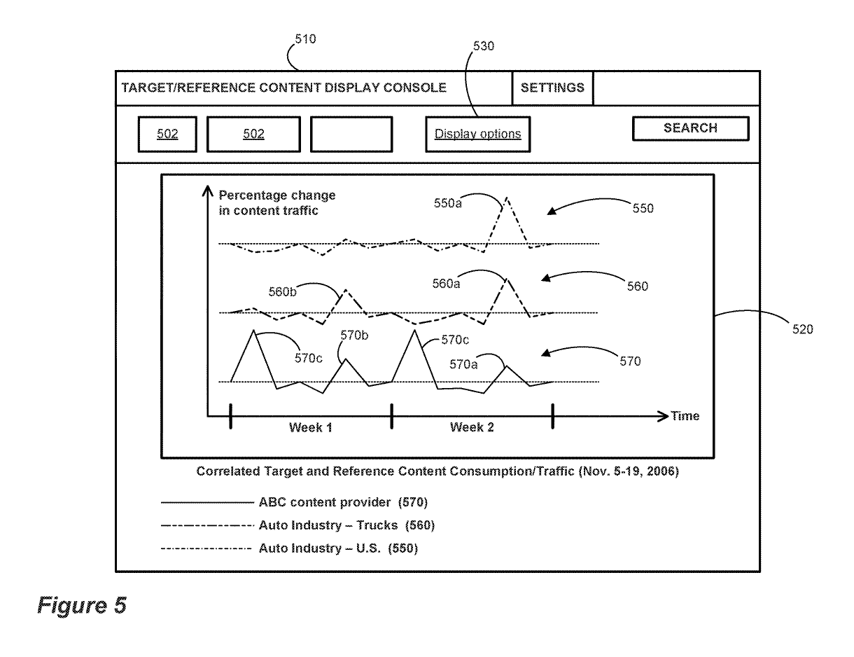

The comparison of target content consumption data and reference content consumption data can be presented in real time as a correlation of data. Such correlations permit content providers to evaluate peak demands on equipment such as servers and end user demand for updated and new content. FIG. 5 illustrates a non-limiting example of an admin console 510 or other user interface that provides relative content consumption, traffic and/or other metrics, data and/or information in a graphical depiction 520. In the exemplary depiction 520 there are three traffic flow charts 550, 560, 570 that represent percentage changes in content traffic for one target content source and two reference content sources for a two-week period (the charts may be provided in retrospect or in real time for a given admin user). Accompanying correlation data and/or calculations can be provided, though it also is possible to discern information from the graphical depiction. Depending on the type of content consumption data collected and the data provided to an admin user, numerically precise and/or calculable information may be available.

In charts 550, 560, 570 there are several illustrative points. For example, peak 550a in chart 550 shows a relatively large spike in content traffic for the U.S. automotive industry reference content, a generally corresponding spike 560a in chart 560 for the automotive industry truck reference content, and a generally corresponding spike 570a in chart 570 for the target content provider admin user. This could be interpreted as the content provider benefiting from an industry-wide increase in traffic and CDN utilization. Spike 570b of chart 570 for the content provider also appears to correlate with a spike 560b for chart 560 for the truck segment of the automotive industry, which indicates that there may have been a truck-related reason for traffic increase (e.g., a recall of a part used in various brands' vehicles, a drop in gasoline prices, etc.).

However, spikes 570c of chart 570 do not appear to have any correlating spikes or increases in chart 550 or chart 560. This may be significant to the content provider and might assist in planning and/or deploying server capacity, scheduling equipment maintenance, infrastructure expansion (or reduction), etc. In the depiction 520 of FIG. 5, spikes 570a both occur on the first day of each of Weeks 1 and 2 of the graph, so the content provider can plan to make sure that updated content is available prior to that day each week and can also allocate additional origin server capacity on those days to accommodate potentially higher numbers of end user requests and other communications from the CDN. The operator of the content delivery network can conduct similar comparisons and/or utilize comparison data and information generated by content providers and then can likewise use such comparison data and information to adjust the deployment and capacity of CDN components such as servers, communication interface resources, cache nodes, etc.

Comparison data and information might also be correlated to other data or information in the content provider's possession (e.g., advertising schedules, incentive offerings, etc.) that permit assessment of such activities and information that is not directly related to content traffic flow in the content delivery network.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above can be combined in various ways to form multiple embodiments. As a result, the invention is not limited to the specific embodiments described above, but only by the claims and their equivalents.

What is claimed is:

1. A method of operating a content delivery network (CDN) to assess target content consumption, the method comprising:
collecting target content consumption data relating to one or more CDN target content sources, each target content source being defined by one or more target-content-defining criteria;
collecting reference content consumption data relating to one or more CDN reference content sources, each reference content source being defined by one or more reference-content-defining criteria;
comparing the collected target content consumption data with the collected reference content consumption data; and
generating one or more metrics relating to the comparison of the collected target content consumption data with the collected reference content consumption data.

2. The method of claim 1 wherein the target-content-defining criteria comprise one or more URLs.

3. The method of claim 2 wherein the target-content-defining criteria further comprise a time period.

4. The method of claim 1 wherein the reference-content-defining criteria comprise one or more URLs.

5. The method of claim 1 wherein the reference-content-defining criteria comprise at least one of the following: industry definition, network segment definition, geographic definition, IP address definition, URL definition, content type definition, subject matter definition.

6. The method of claim 1 wherein the comparison of the collected target content consumption data with the collected reference content consumption data comprises at least one of the following:
correlating the collected target content consumption data with the collected reference content consumption data;
determining the volume of target content data consumed as a percentage of the reference content data;
determining the number of discrete IP addresses accessing the target content versus the number of discrete IP addresses accessing the reference content;
determining the number of end user requests for target content versus the number of end user requests for reference content.

7. The method of claim 1 wherein the reference-content-defining criteria comprises one or more pre-configured or pre-defined reference content categories.

8. The method of claim 1 further comprising the content delivery network receiving target-content-defining criteria.

9. A computer apparatus to operate a content consumption data collection and processing unit in a content delivery network (CDN), the computer apparatus comprising processing instructions that direct the content consumption data collection and processing unit, when executed by the content consumption data collection and processing unit, to:
collect target content consumption data relating to one or more CDN target content sources, each target content source being defined by one or more target-content-defining criteria;
collect reference content consumption data relating to one or more CDN reference content sources, each reference content source being defined by one or more reference-content-defining criteria;
compare the collected target content consumption data with the collected reference content consumption data; and
generate one or more metrics relating to the comparison of the collected target content consumption data with the collected reference content consumption data.

10. The computer apparatus of claim 9 wherein the target-content-defining criteria comprise one or more URLs.

11. The computer apparatus of claim 10 wherein the target-content-defining criteria further comprise a time period.

12. The computer apparatus of claim 9 wherein the reference-content-defining criteria comprise one or more URLs.

13. The computer apparatus of claim 9 wherein the reference-content-defining criteria comprise at least one of the following: industry definition, network segment definition, geographic definition, IP address definition, URL definition, content type definition, subject matter definition.

14. The computer apparatus of claim 9 wherein comparing the collected target content consumption data with the collected reference content consumption data comprises at least one of the following:
correlating the collected target content consumption data with the collected reference content consumption data;
determining the volume of target content data consumed as a percentage of the reference content data;
determining the number of discrete IP addresses accessing the target content versus the number of discrete IP addresses accessing the reference content;
determining the number of end user requests for target content versus the number of end user requests for reference content.

15. The computer apparatus of claim 9 wherein the reference-content-defining criteria comprises one or more pre-configured or pre-defined reference content categories.

16. The computer apparatus of claim 9 further comprising processing instructions that direct the content consumption data collection and processing unit, when executed by the content consumption data collection and processing unit, to receive target-content-defining criteria.

17. A method of operating a content delivery network (CDN) to assess target content consumption, the method comprising:
collecting target content consumption data relating to one or more CDN target content sources, each target content source being defined by one or more URLs;
collecting reference content consumption data relating to one or more CDN reference content sources, each reference content source being defined by one or more URLs;
comparing the collected target content consumption data with the collected reference content consumption data; and
generating one or more metrics relating to the comparison of the collected target content consumption data with the collected reference content consumption data.

18. The method of claim 17 wherein comparing the collected target content consumption data with the collected reference content consumption data is performed in real time.

19. The method of claim 17 wherein comparing the collected target content consumption data with the collected reference content consumption data comprises correlating the collected data and providing the correlation in a graphical depiction to a display console outside the content delivery network.

20. The method of claim 17 further comprising modifying content delivery network equipment deployment and/or capacity based on the comparison of collected target content consumption data and collected reference content consumption data.
